(19) United States
(12) Patent Application Publication
(10) Pub. No.: US 2007/0077376 A1
(43) Pub. Date: Apr. 5, 2007

(54) Double glazing

(76) Inventors: Masaki Mamiya, Ichihara-shi (JP); Hidemi Kato, Itami-shi (JP)

Correspondence Address: FULBRIGHT & JAWORSKI, LLP, 666 FIFTH AVE, NEW YORK, NY, 10103-3198, US

(21) Appl. No.: 11/542,872

(22) Filed: Oct. 3, 2006

(30) Foreign Application Priority Data
Oct. 4, 2005 (JP) 2005-291454
Feb. 8, 2006 (JP) 2006-031256

(51) Int. Cl. E06B 3/00

(52) U.S. Cl. 428/34

(57) ABSTRACT

A double glazing comprising a pair of glass sheets attached in face-to-face juxtaposition to each other and an elongate spacer disposed between opposing faces of the glass sheets along entire peripheral edges thereof for maintaining a gap therebetween. A first seal interposed between each of the opposing faces of the glass sheets and each lateral face of the spacer. A second seal disposed at an inter-edge space formed by the glass sheets adjacent an outer face of the spacer exposed to the outside. A desiccant charged at a space formed within the spacer to maintain the sealing effect of the seals on the sealed space and to readily maintain dry condition of the sealed space. The spacer comprises a channel-forming spacer outer frame portion having a channel bottom portion disposed on the side of the second seal and a desiccant accommodating portion for accommodating the desiccant within the channel of the spacer outer frame portion. At least one channel lateral wall portion of the spacer outer frame portion is movable to/away from a lateral wall portion of the desiccant accommodating portion along the thickness direction of the glass sheets.

### RELATED APPLICATION

This application claims priority from Japanese Patent Application Nos. 2005-291454 filed Oct. 4, 2005 and 2006-031256 filed Feb. 8, 2006, incorporated by reference in their entireties.

### TECHNICAL FIELD

The present invention relates to a double glazing comprising a pair of glass sheets attached in face-to-face juxtaposition to each other, an elongate spacer disposed between opposing faces of the glass sheets along entire peripheral edges thereof for maintaining a gap therebetween, a first seal interposed between each of the opposing faces of the glass sheets and each lateral face of the spacer, a second seal disposed at an inter-edge space formed by the glass sheets adjacent an outer face of the spacer exposed to the outside; and a desiccant charged at a space formed within the spacer.

### BACKGROUND ART

Conventionally, as shown in FIG. 9, a spacer 3 for use in this type of double glazing is provided in the form of a cylindrical (hollow) member having a rectangular cross section. And, this spacer is formed of a deformation-resistant rigid material in order to maintain constant the distance between a pair of glass sheets 1, 2.

The spacer contacts respective opposing faces of the glass sheets 1, 2 via a first seal 4 so as to prevent intrusion of vapor-containing ambient air into the sealed space A formed between the glass sheets 1, 2. To this end, the first seal 1 is formed preferably of such material as isobutylene-isoprene rubber or the like, which has high vapor-proof performance.

On the outer side of the spacer 3 and adjacent the outermost peripheral edges of the glass sheets 1, 2, there is provided a second seal 5 for proving further enhanced sealing. This second seal 5 is formed of such material as silicone sealant, which, desirably, has not only vapor proof performance, but also high bonding strength.

At the inner space formed within the spacer 3, there is charged a desiccant 7, and a plurality of through holes 10 are formed in the inner face of the spacer 3 which faces the sealed inner space A. The desiccant 7 adsorbs water vapor present if any in the sealed space A which enters the through holes 10. As a result, the sealed inner space A of the double glazing can be maintained under a dry condition.

In the above construction, the material forming the first sealant 1 often has plastic deformability, in addition to the high vapor-proof performance.

Then, when the double glazing is subjected to a variable external force such as a wind force, thermal expansion/contraction of air present inside the sealed space due to temperature fluctuation, this will cause bending deformation in the glass sheets constituting the double glazing. Then, this bending deformation leads to relative displacement between the spacer 3 and the glass sheets 1, 2, which results, in turn, in change (increase/decrease) in the distance therebetween at some portions thereof. In the course of this, the first seal 4 is subjected to the external force, so that the first seal 4 may be displaced to/away from the gap between the spacer 3 and the glass sheet 1, 2.

Such phenomenon as described above occurs in repetition when the double glazing is used for an extended period of time. As a result, the plastically deformed first seal 4 can provide only deteriorated sealing performance, thus impairing the air-tightness at the sealed space A. Consequently, vapor-containing ambient air can now enter the sealed space A, in which the vapor may cause dew formation.

In view of the above-described problem as described in the International Published Patent Application WO 2005/049521 (FIG. 2A), discloses a technique for reducing possibility of such sealing performance deterioration of the first seal 4 even when subjected to the variable external force. Referring more particularly to this technique, as shown in FIG. 10, the inner side of the spacer 3 facing the sealed space A is formed of a pair of face forming members which are partially overlapped with each other, thus allowing relative displacement between these face forming members in the direction of thickness of the double glazing.

With this technique, when there occurs bending deformation in the opposed glass sheets 1, 2 subjected to the variable external force, the spacer 3 having the above-described construction can readily follow this bending deformation. Hence, application of the external force to the first seal 4 can be effectively restricted as the force is absorbed by the mutual displacement between the face forming members. Consequently, the deterioration in the sealing performance of the first seal 4 can be avoided.

In the case of the double glazing described in Patent Document 1, the shape of the spacer follows bending deformation in the glass sheets, in the course of which there occurs a change in the volume of the desiccant accommodating space formed inside the spacer.

More particularly, as shown in FIG. 10(b), in case the bending deformation occurs in the mutually separating direction of the glass sheets 1, 2, a width H1 of the spacer 3 increases relative to its normal width H0 thereof (shown in FIG. 10(a)), thus increasing the volume of the desiccant accommodating space.

On the other hand, incase the bending deformation occurs in the mutually approaching direction of the glass sheets 1, 2, as shown in FIG. 10(c), a width H2 of the spacer 3 decreases relative to the normal width H0, thus decreasing the volume of the desiccant accommodating space.

If the desiccant accommodating space changes in its volume, thus in its shape also, positions of the desiccant 7 particles charged in the desiccant accommodating space change also.

If such increase/decrease in the width of the spacer occurs repeatedly, especially, in the case of the decrease thereof, the respective desiccant 7 particles can be crushed as being subjected to a pressing force from the side walls of the spacer.

This phenomenon tends to occur more conspicuously at a vertically disposed portion of the spacer (see FIG. 1).

More particularly, at this vertically disposed portion, each desiccant 7 particle tends to move downward under the effect of gravity. In this, if the spacer is deformed to increase the volume of the desiccant accommodating space, due to the weight of the desiccant particles located at upper positions, the desiccant 7 will be displaced in such a manner that the charging density of the respective desiccant particles located at lower positions will increase, thus making displacement of these lower particles increasingly difficult.

Then, if the spacer is deformed this time to decrease the volume of the desiccant accommodating space under the above-described condition, the pressing force applied from the lateral faces of to the spacer 3 will easily crush the desiccant particles accommodated therein.

The crushing of the desiccant particles will make it difficult to maintain the sealed inner space under an appropriate dry condition or the crushed particles or powder may be diffused into the sealed space, thus impairing the appearance of the double glazing.

In view of the above-described state of the art, a primary object of the present invention is to provide a double glazing which overcomes the above-described problem and which can readily maintain the sealed space under the dry condition by effectively prolonging the sealing effect of the seal to the sealed space.

### OBJECT AND SUMMARY OF THE INVENTION

For accomplishing the above-described object, according to a first characterizing feature of the present invention, there is provided a double glazing comprising: a pair of glass sheets attached in face-to-face juxtaposition to each other; an elongate spacer disposed between opposing faces of the glass sheets along entire peripheral edges thereof for maintaining a gap therebetween; a first seal interposed between each of the opposing faces of the glass sheets and each lateral face of the spacer; a second seal disposed at an inter-edge space formed by the glass sheets adjacent an outer face of the spacer exposed to the outside; and a desiccant charged at a space formed within the spacer;

wherein said spacer includes a channel-forming spacer outer frame portion having a channel bottom portion disposed on the side of said second seal and a desiccant accommodating portion for accommodating the desiccant within the channel of said spacer outer frame portion; and

at least one channel lateral wall portion of the spacer outer frame portion is movable to/away from a lateral wall portion of the desiccant accommodating portion along the thickness direction of the glass sheets.

With the above-described first characterizing construction, the gap between the peripheral edges of the glass sheets is sealed under a highly sealed state by the spacer, the first seal and the second seal disposed on the outer side thereof.

In the above, if the double glazing is subjected to a variable external force such as a wind force, a force generated by expansion/contraction of the air present inside the sealed space due to temperature fluctuation, this causes bending deformation in the glass sheets constituting this double glazing.

This is a phenomenon of a mutual displacement between the spacer and the glass sheets causing mutually approaching/separating movement therebetween. However, according to the above-described construction of the invention, as the one channel lateral wall portion of the spacer outer frame portion and the lateral wall portion of the desiccant accommodating portion are movable to/away from each other along the thickness direction of the glass sheets, the outer width size of the spacer per se follows such bending deformation of the glass sheets.

As a result, it is possible to prevent application of a large stress to the first seal, so that the first seal can continuously provide good sealing effect for an extended period of time.

Further, with the above-described constriction, the volume of the desiccant accommodating portion hardly changes due to change in the outer width of the spacer. Hence, the crushing of the desiccant particles inside the desiccant accommodating space, which would occur in the conventional construction. Consequently, the dry condition of the sealed space can be maintained easily. And, as there occurs no diffusion of crushed desiccant particles into the sealed space, there occurs no impairing of the appearance of the double glazing, either.

Hence, the invention has provided an improved double glazing having a higher commercial value with improved appearance, which has lower possibility of fogging inside the sealed space even when the glazing is used for an extended period of time at a place tending to be subject to vibrations due to a strong wind pressure, such as in a windshield of a high-speed train, etc.

According to a second characterizing feature of the present invention, said spacer outer frame portion and said desiccant accommodating portion are formed integral by bending a single metal plate.

With this second characterizing feature, the spacer can be formed by using a thin plate. Hence, compared with a conceivable construction wherein the spacer outer frame portion is formed by the extrusion technique, the spacer can be formed lighter, hence, the double glazing too can be formed lighter. As a result, the handling of the double glazing can be improved.

Further, since the spacer can be made easily and with less material, the cost reduction is made possible.

According to a third characterizing feature of the present invention, said spacer outer frame portion and said desiccant accommodating portion are formed of separate elements and said spacer outer frame portion includes a retaining portion for retaining said desiccant accommodating portion within the channel.

With this third characterizing feature, by providing the spacer outer frame portion and the desiccant accommodating portion are two separate elements, during the above-described bending deformation of the glass sheets, the following deformation of the spacer outer frame portion following the bending deformation of the glass sheets can hardly be restricted by the desiccant accommodating portion. As a result, the following performance of the outer frame portion is further improved; hence the durability of the second seal can be improved also.

On the other hand, as the desiccant accommodating portion is hardly affected by the following deformation of the spacer outer frame portion, crushing of the desiccant and diffusion of crushed desiccant into the sealed space can be avoided also, so that the dry condition of the sealed space can be maintained for an extended period of time.

Further, as the desiccant accommodating portion is retained to the spacer outer frame portion via the retaining portion, there occurs no inadvertent separation therebetween.

According to a fourth characterizing feature of the present invention, said spacer outer frame portion is formed of a metal and said desiccant accommodating portion is formed of a resin, and said spacer outer frame portion and said desiccant accommodating portion are formed integral with each other.

With this fourth characterizing feature, as the spacer outer frame portion is formed of a metal, intrusion of vapor or dampness can be prevented in a more reliable manner, so that the vapor proofing performance can be further enhanced. Further, as the desiccant accommodating portion is formed of a resin, the spacer can be formed light also.

Still further, as the spacer outer frame portion and the desiccant accommodating portion are formed continuously with each other, the strength of the spacer can be improved.

### BRIEF DESCRIPTION OF THE DRAWINGS

FIG. 1 is a partially cutaway perspective view showing a double glazing,

FIG. 2 is a section showing an edge portion of the double glazing,

FIG. 3 is a section of the edge portion illustrating the function of the double glazing,

FIG. 4 is a section showing an edge portion of a double glazing relating to a further embodiment,

FIG. 5 is a section showing an edge portion of a double glazing relating to a still further embodiment,

FIG. 6 is a section showing an edge portion of a double glazing relating to a still further embodiment,

FIG. 7 is a section showing an edge portion of a double glazing relating to a still further embodiment,

FIG. 8 is a section showing an edge portion of a double glazing relating to a still further embodiment,

FIG. 9 is a section showing an edge portion of a double glazing relating to a conventional art, and

FIG. 10 is a section showing an edge portion of a double glazing relating to a further conventional art.

### DETAILED DESCRIPTION OF THE EMBODIMENTS

Next, embodiments of the present invention will be described with reference to the accompanying drawings. In the drawings, those members and portions identical to the conventional constriction are denoted with identical reference marks or numerals.

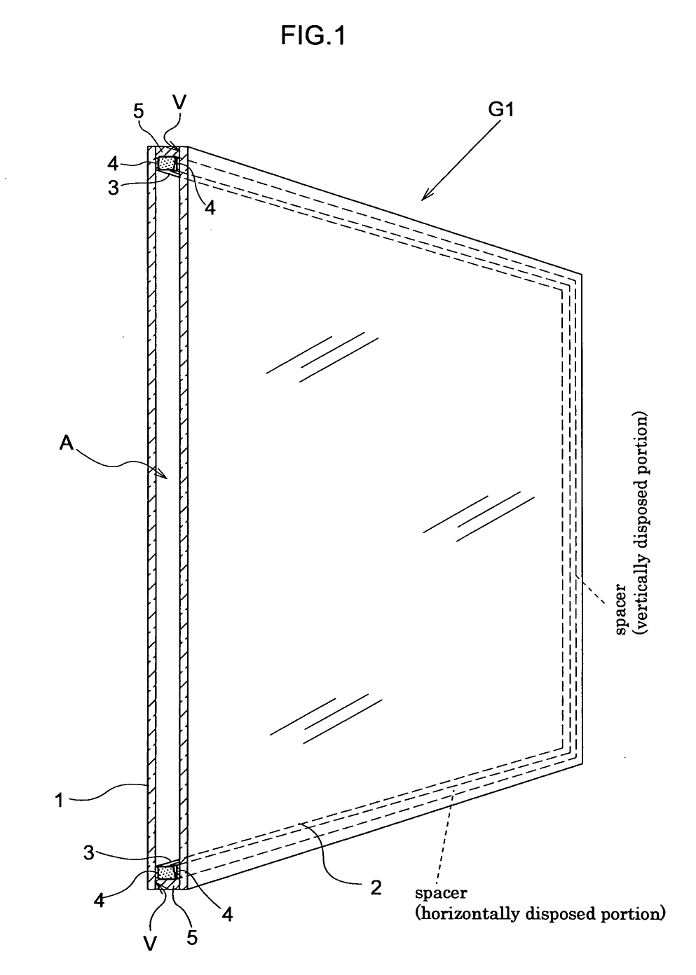

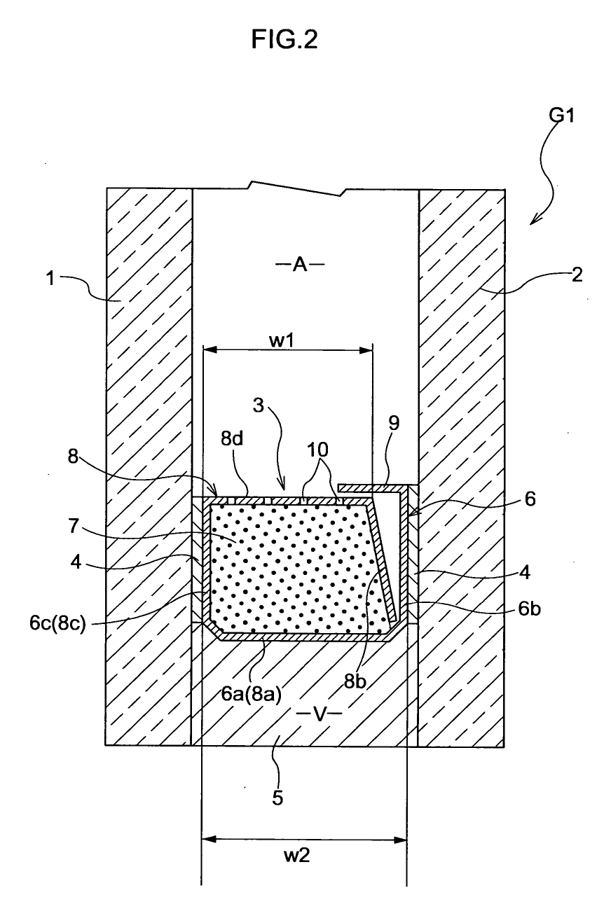

FIGS. 1 and 2 show a first embodiment of a double glazing relating to the present invention.

A double glazing G1 includes a pair of glass sheets 1, 2 disposed in parallel with each other via a spacer 3. Further, between the spacer 3 and each glass sheet 1, 2, there is interposed a first seal 4 made of polyisobutylene, and at an inter-glass sheet edge space V on the outer side of the first seal 4, there is charged a second seal 5 made of silicone seal, whereby a sealed (inner) space A is formed between the first and second glass sheets 1, 2.

In this way, there is provided a double glazing which is to be fixedly fitted to a sash frame installed in e.g. a building construction.

The spacer 3 is formed of aluminum and disposed along the entire peripheral edges of the first and second glass sheets 1, 2 (see FIG. 1).

Further, this spacer 3 includes a channel-like spacer outer frame portion 6 having a channel bottom 6a adjacent the inter-glass sheet edge space V and a desiccant accommodating space 8 accommodating a desiccant 7 in the form of particles within the channel of the spacer outer frame portion 6.

One channel lateral wall portion 6b of the spacer outer frame portion 6 is movable to/away from a lateral wall portion 8b of the desiccant accommodating portion 8 along the thickness direction of the glass sheets 1, 2.

Specifically, the spacer outer frame portion 6 and the desiccant accommodating portion 8 are formed integral by bending a single metal plate.

More particularly, as shown in FIG. 2, the spacer 3 includes, from one lateral side to the other lateral side of the metal plate, the one channel lateral wall portion 6b of the spacer outer frame portion 6, a channel bottom portion 6a of the spacer outer frame portion 6, the other channel lateral wall portion 6c, a ceiling portion 8d of the desiccant accommodating portion 8 and one lateral wall portion 8b of the desiccant accommodating portion 8, with these portions being formed continuously. And, the spacer 3 is formed by bending the metal plate at the border between respective adjacent portions in such a manner that the one channel lateral wall portion 6b of the spacer outer frame portion 6 is overlapped (bent or folded) outwardly over and movable to/away from the one lateral wall portion 8b of the desiccant accommodating portion 8.

In the spacer 3 of this particular embodiment, the channel bottom portion 6a and the other channel lateral wall portion 6c of the spacer outer frame portion 6 constitute also a bottom portion 8a and the other lateral wall portion 8c of the desiccant accommodating portion 8, respectively.

From the edge of the one channel lateral wall portion 6b of the spacer outer frame portion 6, there is continuously formed a bent portion 9 which comes into contact with the top surface of the ceiling portion 8d of the desiccant accommodating portion 8 so as to prevent floating of this ceiling portion 8.

The ceiling portion 8d of the desiccant accommodating portion 8 defines a number of vent holes 10 spaced apart from each other along the length of this portion so as to allow drying of the sealed space A with the desiccant 7 accommodated within the desiccant accommodating portion 8.

Incidentally, a width w1 of the ceiling portion 8d of the desiccant accommodating portion 8 may be same as a width w2 of the channel bottom portion 6a of the spacer outer frame portion 6b. In this particular embodiment, however, the width w1 is set to be slightly shorter than the width w2, as shown in FIG. 2.

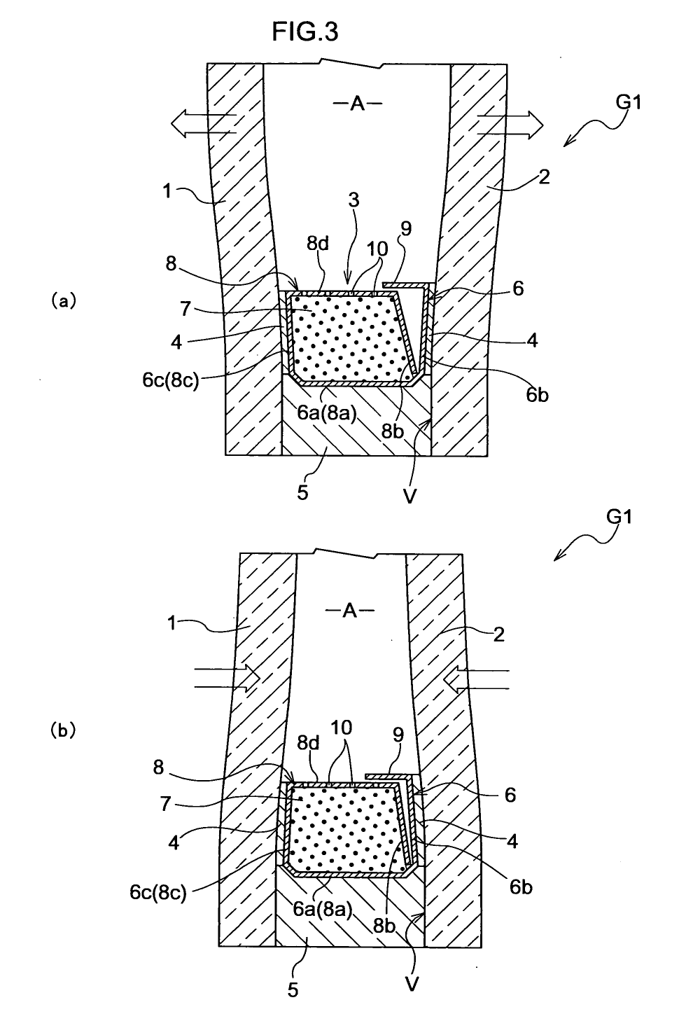

Therefore, according to the double glazing G1 of this embodiment, for instance, when the double glazing G1 is subjected to a variable external force, thus causing bending deformation in the glass sheets 1, 2 constituting the double glazing G1, the one channel lateral wall portion 6b of the spacer outer frame portion 6 can be pivoted in the thickness direction of the glass sheets along the thickness direction of the glass sheets (FIG. 3). In this way, the channel lateral wall portion 6b can follow bending deformation in the glass sheets 1, 2, thereby preventing application of excessive stress to the first seal 4. As a result, the sealing effect can be maintained for an extended period of time.

Further, even when the bending deformation occurs, as any stress is hardly applied to the desiccant 7 inside the desiccant accommodating portion 8, crushing of the desiccant 7 can be avoided, so that the dry condition of the sealed space A can be maintained for an extended period of time.

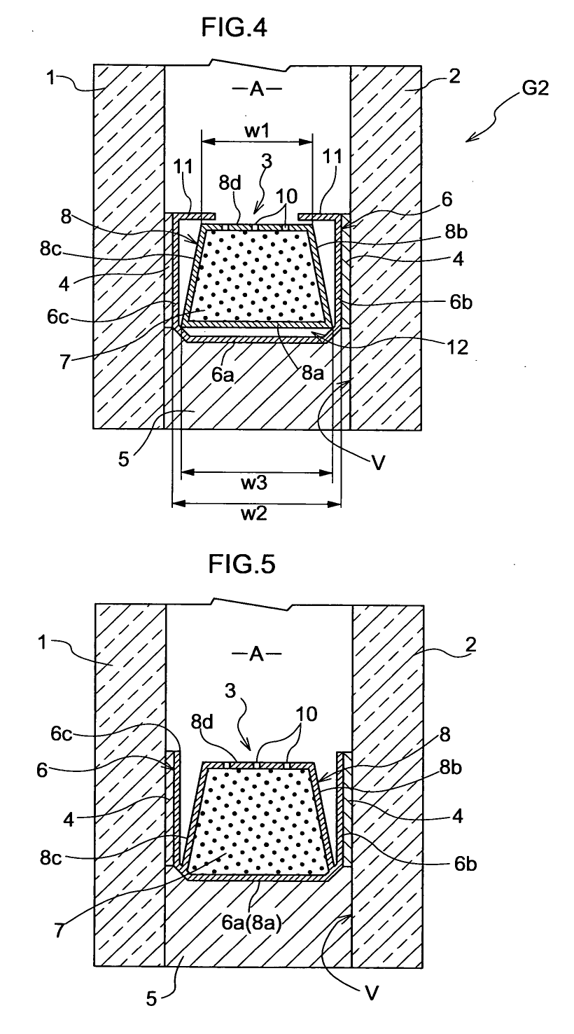

FIG. 4 shows a second embodiment of the double glazing relating to the present invention. The following discussion of this second embodiment concerns mainly portions thereof different from the foregoing embodiment, with discussion of the other portions same as the foregoing embodiment being omitted.

A double glazing G2 of this second embodiment differs in the construction of the spacer 3 from the foregoing embodiment. Specifically, with the spacer 3 of this second embodiment, the spacer outer frame portion 6 and the desiccant accommodating portion 8 are provided as separate elements.

Namely, the spacer outer frame portion 6 comprises a channel bottom portion 6a and a pair of channel lateral wall portions 6b, 6c extending upward continuously from opposed lateral ends of the channel bottom portion 6a. On the other hand, the desiccant accommodating portion 8 comprises a rectangular cylindrical ember sized to be fitted within the channel of the spacer outer frame portion 6.

At an end of each of the channel lateral wall portion 6b, 6c of the spacer outer frame portion 6, there is provided a bet portion (corresponding to a “retaining portion”) 11 for non-detachably retaining the desiccant accommodating portion 8 fitted within the channel.

As shown in FIG. 4, the spacer outer frame portion 6 is formed with chamfering at its bent edges so as to create a space 12 under the desiccant accommodating portion 8 when this desiccant accommodating portion 8 is engaged within the spacer outer frame portion 6. Further, the channel bottom portion 6a of the spacer outer frame portion 6 is formed flat.

With these arrangements, when this spacer 3 is bent at corners of the double glazing, the spacer 3 can be bent with maintaining a relatively regular shape thereof.

The width w3 of the bottom portion 8a of the desiccant accommodating portion 8 is set substantially same as the width w2 of the channel bottom portion 6a of the spacer outer frame portion 6. On the other hand, the width w1 of the ceiling portion 8d is set smaller than the width w3 of the bottom portion 8a. With these, the channel lateral wall portion 6b of the spacer outer frame portion 6 is configured to be moveable to/away from the lateral wall portion 8b of the desiccant accommodating portion 8 along the thickness direction of the plate glasses.

Next, some other embodiments of the invention will be described, respectively.

The spacer 3 can be formed not only of aluminum, but of other kinds of metal or synthetic resin. Especially, if the spacer 3 is formed of a synthetic resin, the long term durability of the spacer against application of large external force may be slightly deteriorated, compared with the aluminum spacer of the foregoing embodiment. However, if the spacer is expected to withstand only a smaller external force, then, the spacer formed of synthetic resin can be formed lightly, while effectively preventing displacement of the seal.

The spacer 3 need not necessarily be formed of a metal plate. Instead, the spacer 3 can be formed by other forming or molding method such as the extrusion method.

As shown in FIG. 5, the spacer 3 can be constructed such that the spacer outer frame portion 6 and the desiccant accommodating portion 8 are formed integral with each other and the channel bottom portion 6a of the channel-like spacer outer frame portion 6 serves also as the bottom portion 8a of the desiccant accommodating portion 8.

In this case, both channel lateral wall portions 6b, 6c of the spacer outer frame portion 6 are configured to be movable to/away from the lateral wall portion 8b of the desiccant accommodating portion 8.

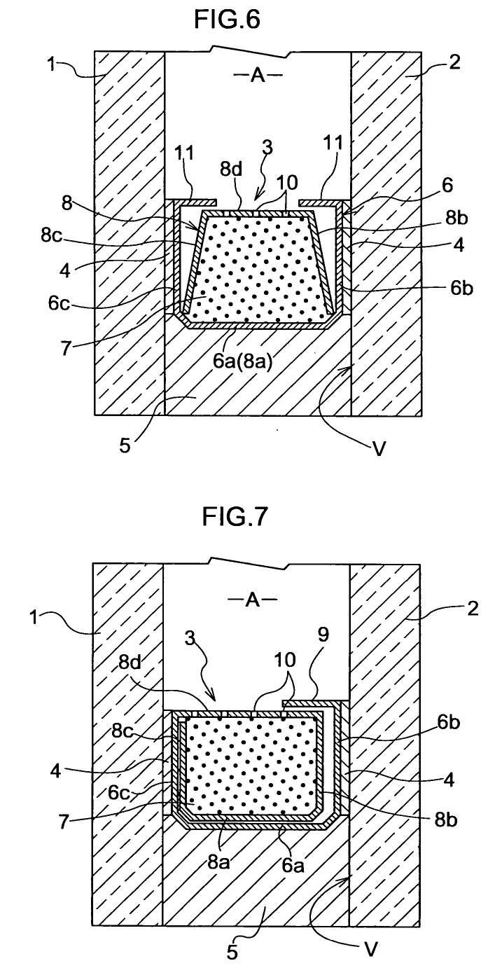

As shown in FIG. 6, the spacer 3 can be constructed such that the spacer outer frame portion 6 and the desiccant accommodating portion 8 are provided as separate elements and the channel bottom portion 6a of the channel-like spacer outer frame portion 6 serves also as the bottom portion 8a of the desiccant accommodating portion 8.

As shown in FIG. 7, the spacer 3 can be formed such that the spacer outer frame portion 6 and the desiccant accommodating portion 8 are formed continuously and integrally with each other, with the desiccant accommodating portion 8 being overlapped inwardly with the channel bottom portion 6a and the other channel lateral wall portion 6c of the spacer outer frame portion 6. This construction is advantageous in more effectively preventing leak of the desiccant 7 accommodated in the desiccant accommodating space 8 to the outside.

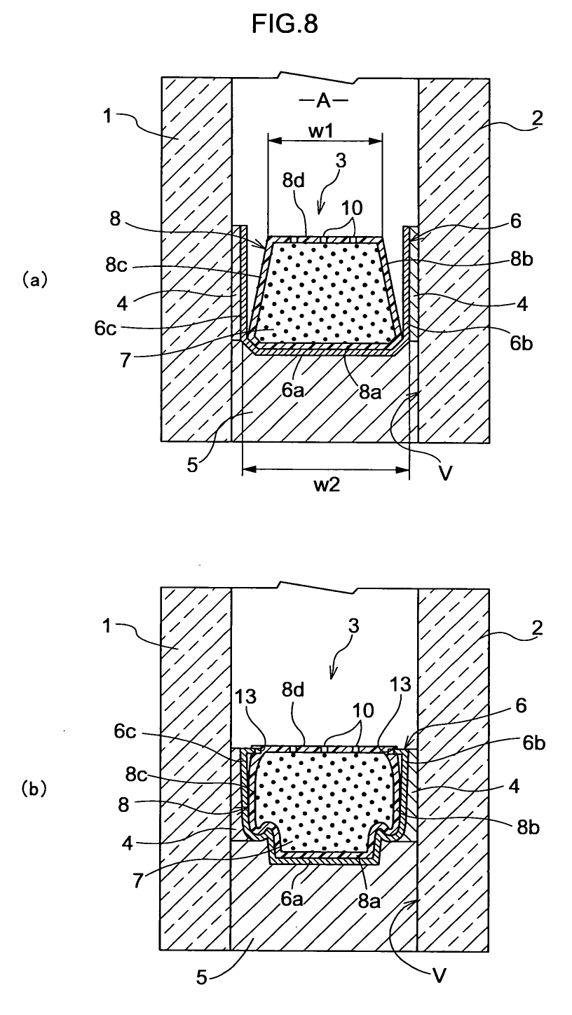

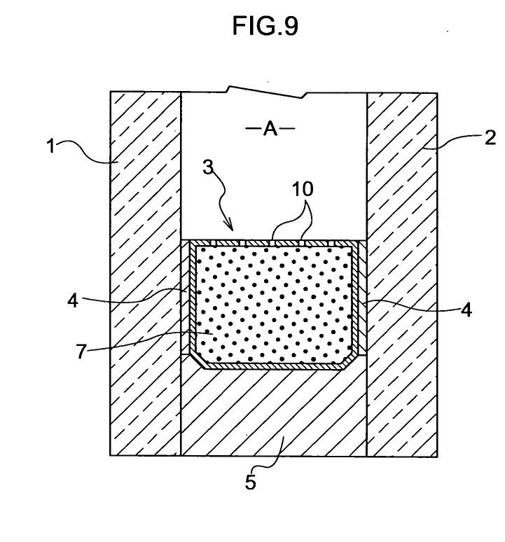

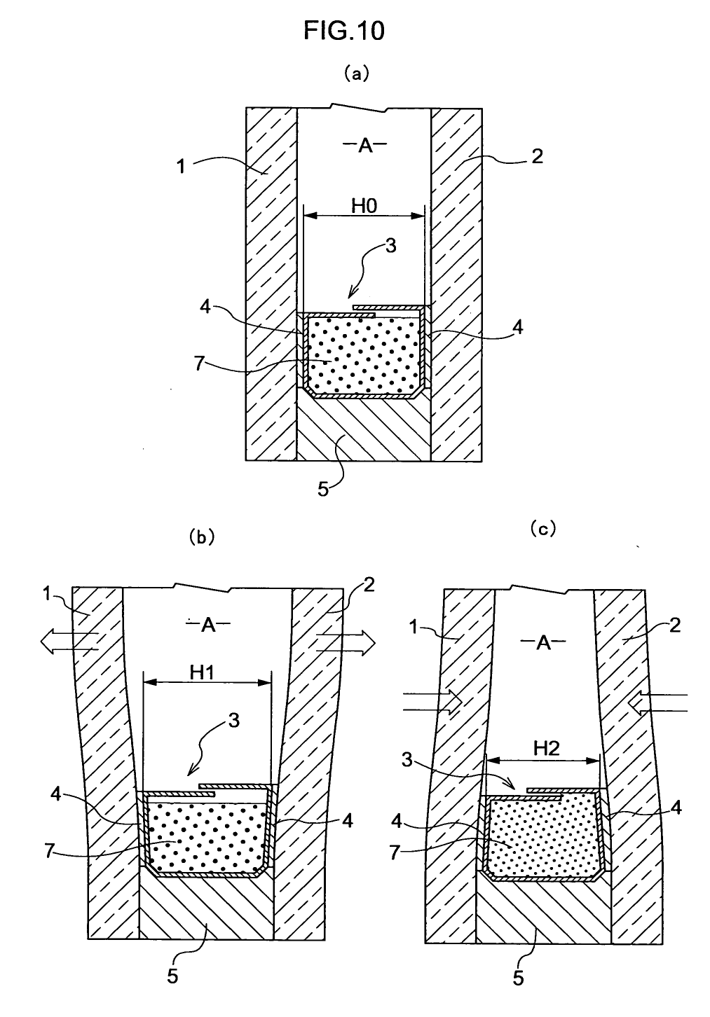

As still further embodiments of the invention, as shown in FIG. 8(a) and FIG. 8(b), the spacer outer frame portion 6 may be formed of a metal such as aluminum, whereas the desiccant accommodating portion 8 may be formed of a resin such as a synthetic resin, and the spacer outer frame portion 6 and the desiccant accommodating portion 8 are formed integral with each other by e.g. the insert molding technique.

Incidentally, in these further embodiments, the channel bottom portion 6a of the spacer outer frame portion 6 and the bottom portion 8a of the desiccant accommodating portion 8 are bonded to each other. However, the channel lateral wall portion 6b and the lateral wall portion 8b and also the channel lateral wall portion 6c and the lateral wall portion 8c are not bonded to and separated from each other, respectively. Therefore, even when the bending deformation occurs in the glass sheets 1, 2 constituting the double glazing, the channel lateral wall portions 6b and 6c of the spacer outer frame portion 6 are pivoted along the thickness direction of the glass sheets, thus following this bending deformation, whereby application of excessive stress to the first seal 4 can be avoided.

In the embodiment shown in FIG. 8(a), the width w1 of the ceiling portion 8d of the desiccant accommodating portion 8 is set slightly shorter than the width w2 of the channel bottom portion 6a of the spacer outer frame portion 6 (w1<w2). This arrangement can render the cross sectional shape of the desiccant accommodating portion 8 even more resistant against deformation when the glass sheets 1,2 constituting the double glazing are contracted at the time of a low temperature.

In the embodiment shown in FIG. 8(b), the lateral wall portions 8b and 8c of the desiccant accommodating portion 8 each defines a receiving groove 13. Then, as the ends of the channel lateral wall portions 6b, 6c engage respectively into these receiving grooves 13, the channel lateral wall portions 6b, 6c can be retained.

And, as the channel lateral wall portions 6b and 6c are retained in the manner described above, the strength of the integral assembly consisting of the spacer outer frame portion 6 and the desiccant accommodating portion 8 of this embodiment can be further increased.

When the glass sheets 1 and 2 are attached and bonded via the first seal 4 with each other into the integral assembly, it is necessary to apply an appropriate pressure to these glass sheets 1, 2. In this respect, with the above-described construction, the integrally molded assembly can very effectively withstand this pressure, so that the integrally molded assembly and the glass sheets can be assembled together in an even more reliable manner, while avoiding break of the desiccant 7.

The “double” glazing is not limited to the assembly of two glass sheets juxtaposed each other. The glazing can be “multiple” glazing having three or more glass sheets attached in juxtaposition via spacers between adjacent glass sheets. Hence, the term “double glazing” as employed herein is understood to include such “multiple” glazing.

Incidentally, although reference marks and numerals have been provided to facilitate reference to the accompanying drawings, it is understood that the provision of these marks and numerals is not to limit the scope of the invention to the constructions shown in the drawings. Needless to say, any skilled artisan could readily modify these constructions conveniently without deviation from the scope of the present invention defined in the appended claims.

The present invention may be used in a double glazing comprising a pair of glass sheets attached in face-to-face juxtaposition to each other, an elongate spacer disposed between opposing faces of the glass sheets along entire peripheral edges thereof for maintaining a gap therebetween; a first seal interposed between each of the opposing faces of the glass sheets and each lateral face of the spacer; a second seal disposed at an inter-edge space formed by the glass sheets adjacent an outer face of the spacer exposed to the outside; and a desiccant charged at a space formed within the spacer.

1. A double glazing comprising:
a pair of glass sheets attached in face-to-face juxtaposition to each other;
an elongate spacer disposed between opposing faces of the glass sheets along entire peripheral edges thereof for maintaining a gap therebetween;
a first seal interposed between each of the opposing faces of the glass sheets and each lateral face of the spacer;
a second seal disposed at an inter-edge space formed by the glass sheets adjacent an outer face of the spacer exposed to the outside; and
a desiccant charged at a space formed within the spacer;
wherein said spacer includes a channel-forming spacer outer frame portion having a channel bottom portion disposed on the side of said second seal and a desiccant accommodating portion for accommodating the desiccant within the channel of said spacer outer frame portion; and
at least one channel lateral wall portion of the spacer outer frame portion is movable to/away from a lateral wall portion of the desiccant accommodating portion along the thickness direction of the glass sheets.

2. The double glazing of claim 1, wherein said spacer outer frame portion and said desiccant accommodating portion are formed integral by bending a single metal plate.

3. The double glazing of claim 1, wherein said spacer outer frame portion and said desiccant accommodating portion are formed of separate elements and said spacer outer frame portion includes a retaining portion for retaining said desiccant accommodating portion within the channel.

4. The double glazing of claim 1, wherein said spacer outer frame portion is formed of a metal and said desiccant accommodating portion is formed of a resin, and said spacer outer frame portion and said desiccant accommodating portion are formed integral with each other.
